(19) United States
(12) Patent Application Publication
(10) Pub. No.: US 2014/0248400 A1
(43) Pub. Date: Sep. 4, 2014

(54) Edible Liquid Filled Polysaccharide Capsules

(71) Applicants: Khamfa Phonchareon, Shanghai (CN); Maurice Gerard Lynch, Waterloo (BE)

(72) Inventors: Khamfa Phonchareon, Shanghai (CN); Maurice Gerard Lynch, Waterloo (BE)

(73) Assignees: FMC CORPORATION, Philadelphia, PA (US); FMC (SHANGHAI) COMMERCIAL ENTERPRISE, Shanghai (CN)

(21) Appl. No.: 14/117,253

(22) PCT Filed: May 11, 2012
(86) PCT No.: PCT/CN12/75335

§ 371 Date: May 20, 2014

(30) Foreign Application Priority Data
May 13, 2011 (CN) 201110124776.0

(51) Int. Cl. A23L 1/22; A23L 2/56

(52) U.S. Cl. CPC A23L 1/22016; A23L 2/56
USPC 426/97; 426/96; 426/590; 426/650

(57) ABSTRACT

Edible capsules include a core surrounded by an encapsulating skin The core is liquid at 25° C. and includes an aqueous mixture of one or more carrageenans, one or more flavorants, and one or more food oils that in total constitute at least 0.5 wt % and at most 30 wt % of the core. The encapsulating skin includes an alginate crosslinked with one or more polyvalent cations, wherein the capsules are nonspherical and seamless.

### SUMMARY OF THE INVENTION

In one aspect, the invention provides edible capsules that include a core surrounded by an encapsulating skin. The core is liquid at 25° C. and includes an aqueous mixture of one or more carrageenans, one or more flavorants, and one or more food oils that in total constitute at least 0.5 wt % and at most 30 wt % of the core. The encapsulating skin includes an alginate crosslinked with one or more polyvalent cations, wherein the capsules are nonspherical and seamless.

In another aspect, the invention provides a method of making the capsules described above. The method includes adding droplets of a first aqueous mixture to a second aqueous mixture under conditions of shear in the second aqueous mixture. The first aqueous mixture includes one or more carrageenans, one or more salts including polyvalent cations, one or more flavorants, and one or more food oils that in total constitute at least 0.5 wt % and at most 30 wt % of the first aqueous mixture; and the second aqueous mixture includes an alginate dissolved in water. The method further includes maintaining the droplets in the second aqueous mixture for a time sufficient to allow the alginate to become crosslinked with the one or more polyvalent cations, thereby forming the encapsulating skin, and then removing the capsules from the second aqueous mixture.

### BRIEF DESCRIPTION OF THE DRAWING

FIG. 1 is a photograph of liquid center sacs prepared according to the invention.

### DETAILED DESCRIPTION OF THE INVENTION

In the specification, examples, and claims, unless otherwise indicated, percents are percents by weight. Except where indicated by context, terms such as “alginate,” “carrageenan”, “flavorant,” “divalent cation,” “polyvalent cation,” “additive,” and similar terms also refer to mixtures of such materials. All temperatures are in ° C. (Celsius) unless otherwise indicated.

The invention provides edible capsules in the form of small sacs filled with a center that is liquid at ambient temperature (25° C.) and that comprises a food oil, flavorants and an aqueous phase. Although the capsules are edible, they may nonetheless be used both for food products and for non-food products. In some particular applications, the sacs may be used for providing a suitable flavor and texture to a beverage, and for simplicity and clarity the capsules/sacs will be described hereinafter in that exemplary context. It is to be understood, however, that they may instead be used for other purposes.

In some embodiments of the invention the sacs may contain fruit flavorants and have a texture that resembles that of natural fruit pulps. One particularly desirable example resembles the sacs derived from oranges, and for sake of simplicity the sacs/capsules of the invention will often be referred to as orange sacs although it is to be understood that the sacs may instead include other flavors. The orange sacs are in the form of capsules with an oblong shape resembling that of natural orange pulps or other citrus based pulps. The sacs have sufficient strength and integrity that they can withstand rigorous manufacturing processes such as pasteurization at the time of manufacture, as well as the strong turbulent flow encountered in ultra-high temperature (UHT) processing of drinks containing the sacs as texturizing agents. The sacs may be incorporated into an aqueous medium as part of a beverage, which may contain other typical beverage ingredients.

The method of making the edible capsules involves adding droplets of a first aqueous mixture comprising an aqueous solution (hereinafter Solution A) with one or more food oils dispersed in it, to a second aqueous mixture (hereinafter Solution B) under conditions of shear in the second aqueous mixture, resulting in encapsulation of the Solution A and oils by a skin that includes crosslinked components from Solution B. Solution A includes water, one or more carrageenans, one or more salts of polyvalent cations, and one or more flavorants (for example, fruit flavorants and/or sucrose). (The term “solution” is used for Solutions A and B, but it is to be understood that some components may not be fully dissolved.) Solution B includes an alginate dissolved in water. The Solution A droplets are maintained in the Solution B medium for a time sufficient to allow the alginate to become crosslinked with the one or more polyvalent cations, thereby forming the encapsulating skin. The polyvalent cations do not, however, gel the carrageenan(s) in Solution A. After formation the capsules are removed from the Solution B medium, and are typically rinsed and stored as discussed further below. In some embodiments of the invention, the cores and/or the skins of the sacs are free of marmelo mucilage. In some embodiments, the sacs are free of anionic surfactants, cationic surfactants, amphoteric surfactants, and/or nonionic surfactants.

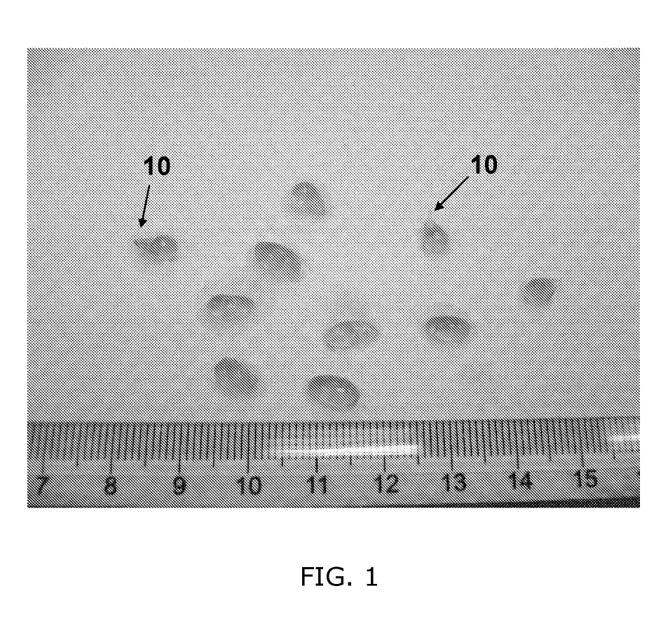

The resulting capsules are non-spherical and seamless, and may have an oval or oblong shape. In some preferred embodiments they have a tapered shape with a tail so that they resemble a tear drop or comet, as shown at feature 10 in FIG. 1. Typically, at least 50 number % or at least 90 number % of the capsules have a length to diameter ratio of at least 1.5 and at most 5.0, or at most 3.0, or at most 2.5. As used herein, the term “length” refers to the longest measurable dimension and the term “diameter” refers to the largest measurable dimension perpendicular to the dimension along which the length is measured.

The ingredients for Solution A and Solution B will now be discussed in detail, followed by Examples demonstrating suitable methods of making the capsules/sacs.

### Solution A

Solution A contains one or more carrageenans. Carrageenan refers to a group of sulfated galactans extracted from red seaweed. Carrageenans are linear chains of D-galactopyranosyl units joined with alternating (1→3) α-D and (1→4) β-D-glycosidic linkages. Carrageenans may, in part, be distinguished by the degree and position of sulfation. Most sugar units have one or two sulfate groups esterified to a hydroxyl group at carbons C-2 or C-6. There are three main types of carrageenan, kappa carrageenan, iota carrageenan, and lambda carrageenan. Kappa carrageenans produce strong rigid gels while those made with iota products are flaccid and compliant. Lambda carrageenans do not gel in water.

Carrageenans typically constitute at least 0.1 wt %, or at least 0.2 wt %, or at least 0.3 wt % of Solution A. Typically they constitute at most 0.7 wt %, or at most 0.6 wt %, or at most 0.5 wt % of Solution A. In some embodiments lambda carrageenan is a component of Solution A, and typically it constitutes at least 10 wt % of the carrageenans, or at least 15 wt %, or at least 20 wt %. Lambda carrageenan typically constitutes at most 70 wt % of the carrageenans, or at most 60 wt %, or at most 50 wt %. Suitable exemplary carrageenans for Solution A are available commercially from FMC BioPolymer under the trade names VISCARIN® GP 209 and VISCARIN® GP 109.

Solution A also contains one or more salts comprising polyvalent cations, which crosslink the alginate provided by Solution B to form the encapsulating skin around the liquid core. Preferred polyvalent ions include divalent and trivalent ions. Suitable polyvalent cations include, for example, calcium(2+), barium(2+), strontium(2+), iron(2+), zinc(2+), copper(2+), and aluminum(3+). Preferred cations are divalent metal cations, more preferably calcium (2+) cations. The cations are provided in the form of one or more food-safe salts. Specific examples of suitable salts include the following, including their hydrates, and mixtures thereof: calcium carbonate, calcium disodium edetate, calcium oxalate, dicalcium phosphate, tricalcium phosphate, tricalcium citrate, calcium sulfate, calcium carbonate, calcium lactate, strontium carbonate, barium carbonate, cupric carbonate, zinc carbonate, zinc oxalate, and zinc phosphate. Calcium nitrate and chloride are not suitable for inclusion in the liquid core, and may be excluded from the compositions used for forming the core.

The one or more salts providing the polyvalent cations are present in an amount sufficient to provide crosslinking of alginate at the surface of the liquid core, thereby forming the capsules/sacs. Typically, the one or more salts will constitute at least 0.1 wt %, or at least 0.2 wt %, or at least 0.3 wt % of Solution A. Typically they constitute at most 0.7 wt %, or at most 0.6 wt %, or at most 0.5 wt % of Solution A.

In some embodiments of the invention, sucrose constitutes at least 10 wt % of Solution A, typically at least 15, 20, 25, 30 or 35 wt %. It constitutes at most 70 wt %, typically at most 65, 60, 55, 50 or 45 wt %.

One or more flavorants are included in Solution A in an amount effective to impart the desired flavor. Typically a fruit flavor will be desired, for example a citrus fruit flavor. Exemplary flavorants include citric acid, potassium citrate, and commercially available flavorings specific to whichever fruit flavor is targeted in a desired application. Exemplary fruit flavors include lemon, lime and orange flavors, available commercially from Givaudan SA of Vernier, Switzerland. Flavorants in total typically constitute at least 0.2 wt %, or at least 0.4, 0.6 or 0.8 wt % of Solution A. The flavorants typically constitute at most 3 wt %, or at most 2.6, 2.2 or 1.8 wt % of Solution A.

Other ingredients may optionally be included in Solution A in minor amounts, and water makes up the balance. Prior to sac formation, an oil phase is dispersed in Solution A to form the aqueous core composition as described below. The oil phase contains a food oil, for example a fish oil and particularly cod liver oil, optionally flavored, and is added at a rate of one part oil to at least 5, 6, 7 or 8 parts of Solution A. Other suitable food oils include vegetable oils, for example, canola, peanut, castor and safflower oil. The oil (optionally including an oil-soluble flavoring) constitutes at least 0.5 wt % of the core, or at least 1 wt %, or at least 2 wt %, or at least 5 wt %. It constitutes at most 30 wt % of the core, typically at most 25, 20 or 15 wt %.

### Solution B

Solution B, which is used as a setting bath, includes one or more alginates. Optionally, it may also include other gel-forming polymers such as pectic substances, carrageenans, glycol alginates, gellan, xanthan and guar gums and soy polysaccharide.

Alginates are salts of alginic acid. Alginic acid, which is isolated from seaweed, is a polyuronic acid made up of two uronic acids: D-mannuronic acid and L-guluronic acid. The ratio of mannuronic acid and guluronic acid varies with factors such as seaweed species, plant age, and part of the seaweed (e.g., stem, leaf).

Alginic acid is substantially insoluble in water. It forms water-soluble salts with alkali metals, such as sodium, potassium, and, lithium; magnesium; ammonium; and the substituted ammonium cations derived from lower amines, such as methyl amine, ethanol amine, diethanolamine, and triethanolamine. The salts are soluble in aqueous media above pH 4, but are converted to alginic acid when the pH is lowered below about pH 4. A water-insoluble alginate is formed if certain polyvalent cations, especially calcium, barium, strontium, zinc, copper(+2), aluminum, and mixtures thereof are present in the medium at appropriate concentrations.

Water insoluble alginate salts, in which the principal cation is calcium, are found in the fronds and stems of seaweeds of the class Phaeophyceae, examples of which are Fucus vesiculosus, Fucus spiralis, Ascophyllum nodosum, Macrocystis pyrifera, Alaria esculenta, Eclonia maxima, Lessonia nigrescens, Lessonia trabeculata, Laminaria japonica, Durvillea antarctica, Laminaria hyperborea, Laminaria longicruris, Laminaria digitata, Laminaria saccharina, Laminaria cloustoni, and Saragassum sp. Methods for the recovery of alginic acid and its water-soluble salts, especially sodium alginate, from natural sources are well known, and are described, for example, in Green, U.S. Pat. No. 2,036,934, and Le Gloahec, U.S. Pat. No. 2,128,551.

Suitable alginates have a weight-average molecular weight of about 20,000 Daltons to about 500,000 Daltons. Weight-average molecular weight is calculated by first determining the intrinsic viscosity, then using the Mark-Houwink Sakurada Equation, as in Martinsen, et al; “Comparison of Different Methods for Determination of Molecular Weights and Molecular Weight Distribution of Alginates” (Carbohydr. Polym., 15, 171-193, 1991).

The preferred alginate molecular weight range may depend upon other ingredients, if any, in Solution B. Typically, about 150,000 Daltons to 500,000 Daltons may be desirable in order to give the encapsulating skin sufficient strength.

The strength of gels formed by reaction of alginate with polyvalent cations is related to the guluronic acid content (“G-content”) of the alginate as well as the arrangement of guluronic and mannuronic acids on the polymer chain. The G-content of the alginate is at least about 30%, preferably about 40% to about 90%, and more preferably about 50% to about 80%. Alginate derived from, for example, Lessonia trabeculata and from the stems of Laminaria hyperborea have the necessary G-content and can be used to form the capsules useful for making the texturizing agents of the invention. Fully saturated alginates with a high G-content give the highest mechanical strength.

The amount of divalent cation, such as calcium, required to react stoichiometrically with these G-blocks can be calculated for each alginate type by considering that two guluronic acid units plus one divalent cation are required to create one ionic crosslink. The amount of calcium required for stoichiometric saturation of a 1% sodium alginate solution are given in the following table:

| Seaweed Source | % G | mM Ca |
|---|---|---|
| Laminaria hyperborea | 70 | 14-16 |
| Laminaria hyperborea | 54% | 11-13 |
| Lessonia trabeculata | 68% | 13-15 |
| Macrocystis pyrifera | 39% | 8-9 |

A list of various commercially available alginates, their properties, and their sources is found in Shapiro, U.S. Pat. No. 6,334,968, Table 1, column 16, line 49, to column 17, line 18, incorporated herein by reference. Mixtures or blends of alginates, for example alginates of different molecular weights and/or G-content, may be used as the gel-forming polymer. Exemplary alginates suitable for use in Solution B are commercially available from FMC BioPolymer under the trade names PROTANAL® GP 4650 and PROTANAL® GP 3550. Blends of these and or other alginates are also suitable.

The one or more alginates are present in Solution B at a concentration sufficient to form a capsule comprising crosslinked alginate around cores comprising Solution A and an oil phase as described above. The alginates typically constitute at least 0.05 wt % of Solution B, or at least 0.10, 0.20, 0.30 or 0.40 wt %. They typically constitute at most 2.0 wt % of Solution B, or at most 1.5, 1.0, 0.8 or 0.6 wt %.

Other gel-forming polymers may optionally be included in Solution B, along with the alginate. Examples include glycol alginates, pectic substances and carrageenan. Glycol alginate is formed by reacting alginate with an alkylene oxide, such as ethylene oxide or propylene oxide. The glycol is bonded to the alginate through the carboxyl groups. Typically, alginate is reacted with propylene oxide to form propylene glycol alginate (PGA). Preparation of propylene glycol alginate is disclosed in Strong, U.S. Pat. No. 3,948,881, Pettitt, U.S. Pat. No. 3,772,266, and Steiner, U.S. Pat. No. 2,426,125. Preferably, the propylene glycol alginate has a degree of esterification of about 40% to about 95%, more preferably about 70% to 95%. Mixtures of propylene glycol alginates of different molecular weights may also be used.

Pectic substances include pectins and pectates. Pectin is a naturally occurring polysaccharide found in the roots, stems, leaves, and fruits of various plants, especially the peel of citrus fruits such as limes, lemons, grapefruits, and oranges. Pectins contain polymeric units derived from D-galacturonic acid. About 20-60% of the units derived from D-galacturonic acid, depending on the source of the pectin, are esterified with methyl groups. These are commercially known as high methoxy pectin and low methoxy pectin, the latter also including amidated pectins. Pectate (pectinate) is fully de-esterified pectin with up to 20% of the units derived from D-galacturonic acid.

Carrageenans are described above. A preferred carrageenan for Solution B is iota carrageenan. Iota carrageenan has a repeating unit of D-galactose-4-sulfate-3,6-anhydro-D-galactose-2-sulfate providing a sulfate ester content of about 25 to 34%. GELCARIN® GP 379, a mixed salt form of iota carrageenan available from FMC BioPolymer, is an exemplary carrageenan suitable for inclusion in Solution B along with the alginate.

Other ingredients may optionally be included in Solution B in minor amounts, and water makes up the balance. The other ingredients may for example include preservatives, for example potassium sorbate, and/or sequestrants. The latter may be included in an amount effective to scavenge hard water cations such as calcium from Solution B to prevent premature alginate crosslinking. One exemplary sequestrant is sodium hexametaphosphate (SHMP), although others may be used.

### Preparing the Sacs

Just prior to forming the sacs, the above described proportions of oil phase and Solution A are combined with vigorous mixing to form a dispersion. The sacs/capsules may then conveniently be prepared by adding drops of the emulsion to a setting bath of Solution B under conditions of shear, resulting in the formation of the desired nonspherical shapes. The droplets are maintained in the Solution B for a time sufficient to allow the alginate to become crosslinked with the one or more polyvalent cations, thereby forming the encapsulating skin. The sacs/capsules are then removed and are typically rinsed with water to remove ungelled alginate from the surface.

The shape, size and texture of the sacs will depend upon the size of the orifice from which the dispersion is dropped, the height from which it is dropped, the exact concentrations of the ingredients in the drops and in the setting bath, the rate of shear in the setting bath, the residence time of the drops in the setting bath, and other parameters that will be within the ability of the skilled person to adjust as needed to obtain a desired effect. For example, one suitable variation is to let the Solution A/oil dispersion drop onto the curved wall of vessel with a concave wall (e.g., a beaker) in which the Solution B is stirred, above the Solution B surface so that the dispersion rolls down the curved wall and into Solution B to form the sacs.

While various shapes and sizes can be made by the above process, in some embodiments at least 90 number percent of the capsules have a diameter of at least 1.0 mm and at most 5.0 mm, and a length that is greater than the diameter and that is at most 15.0 mm. In some embodiments, the length of at least 90 number percent of the capsules is at most 10.0 mm. Capsules meeting these size criteria may be particularly suitable for use as artificial orange sacs.

### EXAMPLES

The following Examples designate the aqueous portion of the liquid center compositions as “Solution A” (to which food oils are added before sac formation) and setting bath compositions as “Solution B”, although in some cases Solution A and/or Solution B may include some suspended undissolved materials. Stock dry ingredient bases for preparing Solutions A and B, designated RESL 0709 and RESL 0710 respectively, are used in some of the Examples. These compositions are as follows.

RESL 0709

| | |
|---|---|
| Carrageenan (VISCARIN ® GP 209) | 50% |
| Ca lactate, food grade | 25% |
| Tricalcium phosphate | 25% |

RESL 0710

| | |
|---|---|
| Alginate (PROTANAL ® GP 4650) | 85% |
| Salts of iota carrageenan (GELCARIN ® GP 379) | 5% |
| Sodium hexametaphosphate (SHMP) | 5% |
| Dextrose | 5% |

The dextrose was used as a standardizing agent in the amount needed to provide the PROTANAL® GP 4650 with a standard gel strength. The SHMP is a sequestrant added to scavenge water hardness to prevent premature crosslinking of the alginate.

### Example 1

Solution A, Solution B and a syrup storage solution were prepared according to the compositions and methods described below.

| Solution A | % (w/w) | Weight (g) |
|---|---|---|
| RESL 0709 | 0.80 | 8.00 |
| K Citrate | 0.20 | 2.00 |
| Citric acid | 0.50-0.60 | 5.00-6.00 |
| Sucrose | 40.00 | 400.00 |
| Color (B-carotene) emulsion | | 0.75 (15 drops) |
| Lime flavor | | 2 mL |
| Orange Flavor | | 2 mL |
| Lemon Flavor | | 2 mL |
| Water | 58.40 | 584.00 |
| Total | 100.00 | 1000.00 |

Solution A was prepared as follows. A mixture of the RESL 0709 with 100 g of sucrose was sprinkled into water at 40° C. under high speed stirring (vortex created), and stirring was continued another 5 minutes. The potassium citrate and the remaining sucrose was added and the mixture was agitated for an additional 5 minutes. The color, flavor and citric acid were added and mixing was continued for 3-4 minutes. Just before sac formation, orange flavored cod liver oil (Scott's Emulsion Cod Liver Oil Orange) was added at a rate of one part to 9 parts of Solution A, with good mixing. This contributed a particularly pleasing color and overall appearance to the product, as well as a nutrient benefit provide by vitamins naturally present in the cod liver oil.

| Solution B | % (w/w) | Weight (g) |
|---|---|---|
| RESL 0710 | 0.50 | 5.00 |
| Potassium sorbate (preservative) | 0.10 | 1.00 |
| Filtered water | 99.40 | 994.00 |
| Total | 100.00 | 1000.00 |

Solution B was prepared by sprinkling RESL 0710 into water at ambient temperature with mixing under a high vortex to avoid fish eye formation. Mixing time was about 10-15 minutes.

| Syrup storage solution | % (w/w) | Weight (g) |
|---|---|---|
| Sucrose | 55.00 | 550.00 |
| Potassium sorbate | 0.10 | 1.00 |
| Citric acid | 0.60 | 6.00 |
| Water | 44.30 | 443.00 |
| Total | 100.00 | 1000.00 |

Syrup solution pH = 3.3 if citric acid is 0.60%
Syrup solution pH = 2.8 if citric acid is 0.70%

Orange sacs were prepared from Solution A and Solution B as follows.

1. With Solution B stirred lightly (light vortex), drop in a slow stream of the Solution A/Scott's Emulsion blend. Adjust the extruding pressure and the drop height to create the desired shape of the imitation orange sacs. Allow 2-3 minutes residence time.

2. Remove the orange sacs and place in strainer. Rinse the orange sacs with water for a few minutes.

3. Fill a plastic pouch with 50% orange sacs and 50% of the storage syrups. Heat seal the pouch. Pasteurize at 80° C. for 10 minutes.

4. Cool promptly in cold water (5-10° C.).

The above preparation method gives orange sacs similar to those shown in FIG. 1, with shapes resembling those of natural orange sacs. The sacs can be heated to temperatures of 80° C. and higher, such as during pasteurizing, without suffering damage. The sacs have a bursting effect upon chewing, releasing the juicy liquid from the center in a manner similar to that of natural orange sacs.

### Example 2

Orange sacs were prepared with and without inclusion of coconut fibers and pectin fibers in Solution B. The solutions and the sacs were prepared according to the method of Example 1, using the following formulations. The sacs were stored in a syrup storage solution prepared according to Example 1.

| | |
|---|---|
| A1 | A2 |

| | | | | |
|---|---|---|---|---|
| RESL 0709 | 8 | g | 10 | g |
| K citrate | 2 | g | 2 | g |
| citrate acid | 5 | g | 5 | g |
| sucrose | 400 | g | 400 | g |
| β-carotene | 1 | g | 1 | g |
| flavor¹ | 6 | mL | 6 | mL |
| water | 584 | g | 582 | g |
| total | ~1000 | g | ~1000 | g |

¹Liquid orange flavor sold by Givaudan

Six compositions of setting solution, designated B1 to B6, were prepared, some with nata de coco fiber or pectin fiber and some without and fiber. See the following table. Sacs were prepared with certain combinations of B1 to B6 with liquid center compositions A1 and A2, without stirring and using a setting time of one minute. The results shown below, with a skin firmness ranking of 1 being worst and 10 being best.

| | B1 | B2 | B3 | B4 | B5 | B6 |
|---|---|---|---|---|---|---|
| Sodium alginate¹ | | | | | 1 | 1 |
| RESL0710 | 0.5 | 1 | 0.5 | 1 | | |
| K sorbate | 0.1 | 0.1 | 0.01 | 0.1 | 0.1 | |
| Nata de coco fiber | | | 5 | | | |
| solution (Hainanyeguo) | | | | | | |
| Pectin fiber (H&F) | | | | 0.5 | | 0.5 |
| Water | 99.4 | 98.9 | 94.49 | 98.4 | 98.9 | 98.5 |
| Total | 100 | 100 | 100 | 100 | 100 | 100 |

¹MANUGEL ™ DMB sodium alginate, FMC BioPolymer

### Results:

| | Skin | |
|---|---|---|
| Treatment | Firmness | |
| A1 + B1 | 5 | cloudy |
| A1 + B2 | 6 | |
| A1 + B3 | 7 | |
| A2 + B1 | 5.5 | |
| A2 + B2 | 8 | |
| A2 + B3 | 5.5 | |

Sacs made with incorporation of pectin fiber or nata de coco fiber had poor skin integrity, while those made without fiber had good integrity.

### Comparative Example 3

An alternative gum, ISAGUM™ GP 9465 Propylene Glycol Alginate (propylene glycol alginate and carboxymethyl cellulose, available from FMC BioPolymer), was used instead of carrageenan to prepare Solution A according to the following composition. The pH of the solution was 3.2.

| | |
|---|---|
| ISAGUM ™ GP 9465 | 0.4% |
| Sucrose | 40% |
| Citric acid | 0.9% |
| Potassium citrate | 0.3% |
| Flavor | 6 mL orange flavor |
| Water | to 100% |

Orange sacs were prepared using the general procedure of Example 1. The sacs had poor shell formation and thin, easily broken skins.

### Example 4

Several formulations for Solution A based on VISCARIN® GP 209 were prepared, varying the calcium source, as shown in the following table. A single or multiple calcium source was used: calcium lactate, calcium sulfate, and/or tricalcium phosphate (TCP). The entries all designate weight percentages except where noted, and all formulations had a pH of 3.2.

Solution A

| | 1 | 2 | 2a | 3a | 3b | 3c |
|---|---|---|---|---|---|---|
| VISCARIN ® | 0.4 | 0.4 | 0.4 | 0.4 | 0.4 | 0.4 |
| GP 209 | | | | | | |
| Ca lactate | 1 | | — | 0.2 | 0.4 | 0.8 |
| CaSO₄ | — | 0.4 | — | — | — | — |
| TCP | — | — | 0.4 | 0.2 | — | — |
| Sucrose | 40 | 40 | 40 | 40 | 40 | 40 |
| Citric acid | 0.6 | 0.6 | 0.6 | 0.6 | 0.6 | 0.6 |
| Potassium | 0.2 | 0.2 | 0.2 | 0.2 | 0.2 | 0.2 |
| citrate | | | | | | |
| Orange | 6 mL | 6 mL | 6 mL | 6 mL | 6 mL | 6 mL |
| Flavor | | | | | | |
| Water | balance | balance | balance | balance | balance | balance |

For Solution B, PROTANAL® GP 3550 and PROTANAL® GP 4650 alginates were each dissolved in water at 0.5% and 1% by weight. Sodium hexametaphosphate (SHMP) may optionally be included as a calcium sequestrant, but was not used in the formulations in the Table above. The solution was prepared by stirring at high speed using a propeller mixer for 15 minutes to dissolve the PROTANAL® alginates. A storage syrup for the artificial sacs was prepared according to the following composition.

Storage Syrup

| | |
|---|---|
| Sucrose | 55% |
| Potassium sorbate | 0.1% |
| Citric acid | to pH 3.8 |
| Water | to 100% |

Note:
0.7% citric acid gives pH ~2.8, and 0.6% citric acid gives pH 3.6

Based on the results obtained in the foregoing Examples, Solution A compositions containing 1 wt % Ca lactate were particularly effective when Solution B contained 1 wt % PROTANAL® alginate, while a combination of 0.2% Ca lactate and 0.2% tricalcium phosphate worked well if Solution B contained 0.5% PROTANAL® alginate and the soaking time in Solution B was longer than three minutes.

### Example 5

The process of Example 1 was modified by using a propeller mixer at low/medium speed to create a light vortex. The orange Solution A was delivered dropwise from a disposable plastic pipette to form the sacs, which were allowed to set for at least two minutes. The setting time was kept to less than three minutes to minimize clumping of the sacs due to adhering together, a problem that sometimes results if the setting time is too long. In this Example, one part of Scott's Emulsion Cod Liver Oil Orange was added to 8-9 parts of Solution A with good mixing, just prior to sac formation. Orange sacs were successfully prepared, but some clumping occurred due to a somewhat excessive setting time (greater than three minutes).

### Example 6

The process of Example 5 was modified by adding a 5% CaCl₂ dip in the last step.

In this case, the orange sacs were allowed to form in the setting bath (Solution B) for a about 1 minute, to ensure that no clumping occurred. The sacs wee then transferred to a strainer, rinsed with cold water and then soaked in 5% CaCl₂ solution for 1-2 minutes. They were then rinsed with water to remove excess CaCl₂, immersed in the storage solution and then pasteurized at 80° C. for 10 minutes. Sacs with stronger skins than those of Example 5 were obtained.

Although the invention is illustrated and described herein with reference to specific embodiments, the invention is not intended to be limited to the details shown. Rather, various modifications may be made in the details within the scope and range of equivalents of the claims without departing from the invention.

What is claimed:

1. Edible capsules comprising a core surrounded by an encapsulating skin;
wherein the core is liquid at 25° C. and comprises an aqueous mixture of one or more carrageenans, one or more flavorants, and one or more food oils that in total constitute at least 0.5 wt % and at most 30 wt % of the core; and
wherein the encapsulating skin comprises an alginate crosslinked with one or more polyvalent cations, and wherein the capsules are nonspherical and seamless.

2. The capsules of claim 1, wherein the encapsulating skin further comprises one or more carrageenans.

3. The capsules of claim 2, wherein the one or more carrageenans in the encapsulating skin comprise iota carrageenan.

4. The capsules of claim 1, wherein the flavorants comprise citric acid and/or potassium citrate and one or more other citrus fruit flavorants.

5. The capsules of claim 1, wherein the flavorants provide an orange flavor.

6. The capsules of claim 1, wherein the flavorants comprise sucrose.

7. The capsules of claim 1, wherein the one or more carrageenans in the core comprise lambda carrageenan.

8. The capsules of claim 1, wherein lambda carrageenan constitutes at least 20 wt % of the one or more carrageenans in the core.

9. The capsules of claim 1, wherein the core further comprises one or more salts comprising polyvalent cations.

10. The capsules of claim 9, wherein the one or more salts comprise calcium salts, provided that the calcium salts do not include nitrate or chloride.

11. The capsules of claim 9, wherein the one or more salts comprise one or both of calcium lactate and tricalcium phosphate.

12. The capsules of claim 1, wherein at least 90 number percent of the capsules have a diameter of at least 1.0 mm and at most 5.0 mm, and a length that is greater than the diameter and is at most 15.0 mm.

13. The capsules of claim 12, wherein the length is at most 10.0 mm.

14. A beverage comprising the capsules of claim 1 in an aqueous medium.

15. A method of making the capsules of claim 1, comprising adding droplets of a first aqueous mixture to a second aqueous mixture under conditions of shear in the second aqueous mixture;
wherein the first aqueous mixture comprises one or more carrageenans, one or more salts comprising polyvalent cations, one or more flavorants, and one or more food oils that in total constitute at least 0.5 wt % and at most 30 wt % of the first aqueous mixture; and
wherein the second aqueous mixture comprises an alginate dissolved in water;
the method further comprising maintaining the droplets in the second aqueous mixture for a time sufficient to allow the alginate to become crosslinked with the one or more polyvalent cations, thereby forming the encapsulating skin, and then removing the capsules from the second aqueous mixture.

16. The method of claim 15, wherein the flavorants comprise fruit flavorants.

17. The method of claim 15, wherein the flavorants comprise sucrose.
